(19) United States
(12) Patent Application Publication
(10) Pub. No.: US 2021/0405586 A1
(43) Pub. Date: Dec. 30, 2021

(54) Watch Dial And Watch

(71) Applicant: Seiko Epson Corporation, Tokyo (JP)

(72) Inventors: Kazunori HOSHINO, Matsumoto (JP); Shogo KOBAYASHI, Shiojiri (JP); Ai YOSHINAGA, Shiojiri (JP); Toshio KOYAMA, Matsumoto (JP); Toshiyuki KUNO, Shiojiri (JP)

(21) Appl. No.: 17/361,517

(22) Filed: Jun. 29, 2021

(30) Foreign Application Priority Data
Jun. 30, 2020 (JP) 2020-112535

(51) Int. Cl. G04B 19/12; G04D 3/00

(52) U.S. Cl. CPC G04B 19/12; G04B 45/0084; G04D 3/0048

(57) ABSTRACT

A watch dial includes a substrate, a protruding portion formed on the substrate by laser machining, and a coating layer provided around the protruding portion. At least a portion of an upper surface of the protruding portion is exposed from the coating layer.

The present application is based on, and claims priority from JP Application Serial Number 2020-112535, filed Jun. 30, 2020, the disclosure of which is hereby incorporated by reference herein in its entirety.

### BACKGROUND

### 1. Technical Field

The present disclosure relates to a watch dial, and a watch provided with the dial.

### 2. Related Art

In known art, in order to enhance decorative and design properties, an improvement is conceivable on a dial that forms the face of a wrist watch. For example, in JP-A-2000-155181, a technology is disclosed for enhancing decorative properties by forming a varied textured pattern on the surface of a dial.

According to JP-A-2000-155181, the dial is configured by laminating an adhesive resin layer, a metal thin film, and a transparent plate on a base substrate, and the metal thin film is covered following the shape of a textured surface formed on the surface of the adhesive resin layer. Note that, with respect to the textured surface of the adhesive resin layer, before the resin layer cures, a flat plate is placed on the resin layer and is pressed evenly, and then, by pulling the flat plate upward, the surface of the resin layer is pulled by the flat plate, thus forming a plurality of textured patterns. Further, a three-dimensional effect of the textured patterns is amplified by the transparent plate provided on the metal thin film.

However, with the dial disclosed in JP-A-2000-155181, there is a problem in that it is difficult to create an intended textured pattern. Specifically, in a known method that relies on a viscosity of the adhesive resin layer, a material of the flat plate, a drawing speed, and the like, there is no regularity in the formed textured patterns, and it is difficult to quantitatively control a position, number, size, shape, and height of recesses and protrusions. In other words, there is a need for a watch dial having high decorative and design properties.

### SUMMARY

A watch dial according to the present application includes a substrate, a protruding portion formed on the substrate by laser machining, and a coating layer provided around the protruding portion. At least a portion of an upper surface of the protruding portion is exposed from the coating layer.

A watch according to the present application includes the watch dial described above.

### BRIEF DESCRIPTION OF THE DRAWINGS

FIG. 1 is a plan view of a watch according to a first embodiment.

FIG. 2 is a flowchart illustrating a flow of a method for manufacturing a dial.

FIG. 3 is a plan view of a substrate.

FIG. 4 is an enlarged view of a mark.

FIG. 5 is a diagram illustrating manufacturing steps of the dial.

FIG. 6 is a diagram illustrating manufacturing steps of the dial.

FIG. 7 is an enlarged photograph of an index.

FIG. 8 is a cross-sectional view of a different mode of protruding portions according to a second embodiment.

FIG. 9 is a cross-sectional view of a different mode of protruding portions according to a third embodiment.

### DESCRIPTION OF EXEMPLARY EMBODIMENTS

First Embodiment

Overview of Watch

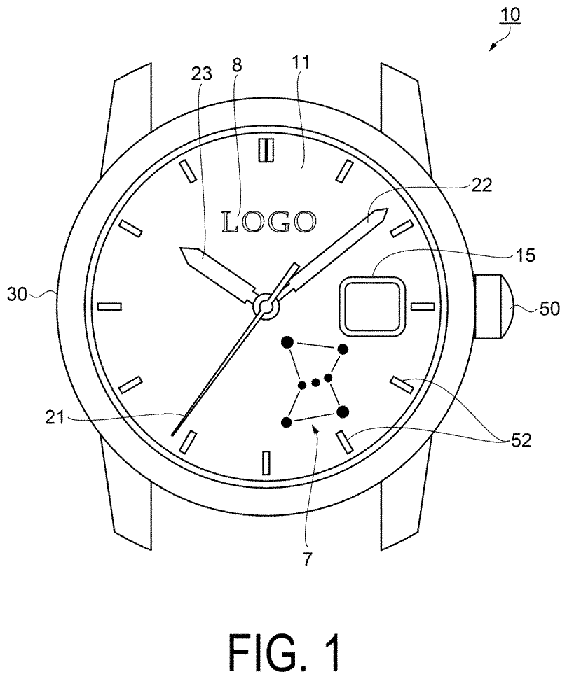

FIG. 1 is a plan view of a watch according to an embodiment.

A watch 10 according to the embodiment is a three-hand analog wrist watch, and is provided with a calendar function.

The watch 10 is configured by a case body 30, a dial 11, a seconds hand 21, a minute hand 22, an hour hand 23, a crown 50, and the like.

The case body 30 is a case, and is configured by a hard metal, such as stainless steel or titanium. Note that a movement (not illustrated) for driving the hands is housed in a back surface of the dial 11 in the case body 30.

A logo 8, a mark 7, a date window 15, indices 52, and the like are provided on the dial 11. An insertion hole (not illustrated) through which shafts of the hands pass is formed in the center of the dial 11 having a circular shape, to attach the seconds hand 21, the minute hand 22, and the hour hand 23.

The logo 8 is a brand or logo of the watch 10. As an example, here, the mark 7 is a starry sky mark schematically portraying an alignment of stars of the constellation of Orion. Note that the mark 7 is not limited to the constellation of Orion, and may be another constellation, a seasonal starry sky or a starry sky representing a birth date or an anniversary, or may be a mark other than the starry sky, such as a symbol or the like. For example, the mark 7 may portray a family crest, a building, a scene, a person, an item, a geographical feature, or the like. The date window 15 is a window frame for displaying the date. The index 52 is a time index.

Since the dial 11 is formed by a manufacturing method to be described below, an underlying texture is rich, and the dial is obtained with the logo 8 and the mark 7 having high decorative properties. Note that this will be described in detail below.

The crown 50 is a crown. When the crown 50 is pulled out to a first stage, the date can be corrected, and when the crown 50 is pulled out to a second stage, the time can be corrected. Note that the crown 50 may include other functions.

Method for Manufacturing Dial

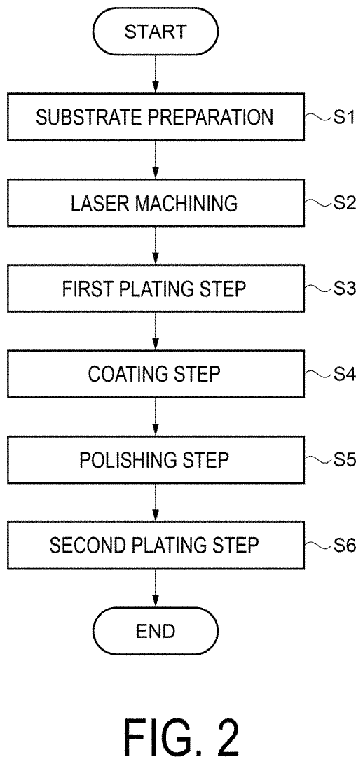

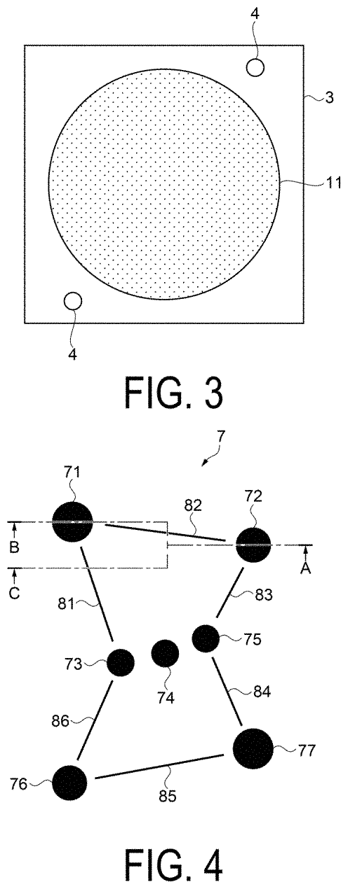

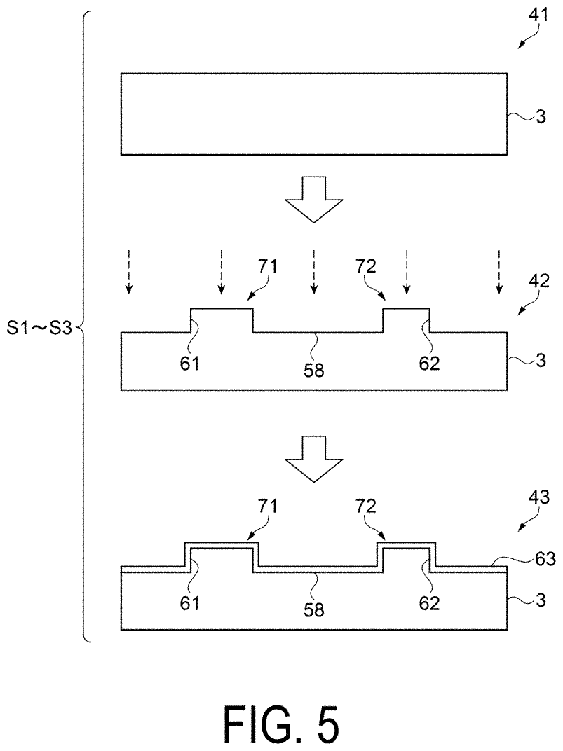

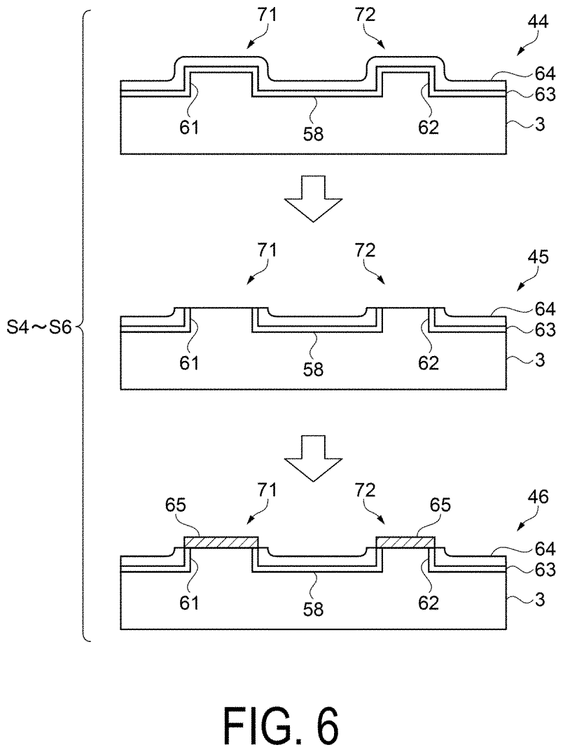

FIG. 2 is a flowchart illustrating a flow of a method for manufacturing the dial. FIG. 3 is a plan view of a substrate. FIG. 4 is an enlarged view of the mark. FIG. 5 and FIG. 6 are diagrams illustrating manufacturing steps of the dial. Here, the method for manufacturing the dial 11 will be described mainly with reference to FIG. 2, and to FIG. 1 to FIG. 6 as appropriate.

At step S1, a substrate 3 is prepared. The substrate 3 illustrated in FIG. 3 is a metal substrate that serves as a base material of the dial 11. In an initial state, as illustrated in FIG. 3, the substrate 3 has a substantially square shape, and the center thereof is a forming area of the circular dial 11. In a preferred example, the substrate 3 uses a brass plate that is approximately 40 mm square and has a thickness of approximately 0.3 mm. The diameter of the dial 11 is approximately 33 mm. Note that the substrate 3 is not limited to this material, and it is sufficient that the substrate 3 be a metal material. For example, nickel silver may be used, a precious metal such as gold, silver, platinum, or the like may be used, or copper, stainless steel or the like may be used. Alternatively, an alloy of these may be used. Further, the thickness of the substrate 3 and the diameter of the dial 11 are not limited to those described above.

As illustrated in FIG. 3, two reference holes 4 are provided on a diagonal line of the substrate 3. In manufacturing steps, 10 to 20 sheets of the substrate 3 are set at a time on a jig provided with reference pins corresponding to the reference holes 4, and in this state of having a position thereof determined, are processed in each of the steps. Note that, in the manufacturing steps, the substrate 3 may flow one at a time and be processed.

At step S2, laser machining is performed on the area of the dial 11 of the substrate 3. In a preferred example, the laser machining uses a laser irradiation device capable of femtosecond ultra-short pulse irradiation. Irradiation using the laser is preferably performed by changing irradiation conditions at a time of machining to etch deep shapes such as protruding portions or the like, and a time of surface finishing including forming shallow patterns. The irradiation conditions include parameters such as an output frequency, a scanning velocity, a laser output, a scan pass pitch, and the like.

Note that, in the following description, a machining mode used for the mark 7 in the dial 11 illustrated in FIG. 1 is exemplified as a representative machining mode. However, similar processing is also performed on the logo 8, the date window 15, and the indices 52 of the dial 11. FIG. 4 is an enlarged view of the mark 7, and a cross-section A-B is a cross section of a protruding portion 72 and a protruding portion 71. FIG. 5 illustrates a mode in which a first convex portion 61 and a second convex portion 62 are formed by the laser machining. Note that a step diagram 42 is a cross-sectional view taken along the cross-section A-B illustrated in FIG. 4.

As illustrated in a step diagram 41 in FIG. 5, by performing laser irradiation on a peripheral region of portions that are to become the first convex portion 61 and the second convex portion 62, with respect to the surface of the unprocessed substrate 3, the first convex portion 61 and the second convex portion 62 are formed, as illustrated in the step diagram 42.

In a preferred example, the heights of the first convex portion 61 and the second convex portion 62 are the same and are approximately 50 μm. In other words, the periphery is machined until the height of the first convex portion 61 and the second convex portion 62 is approximately 50 μm. A reference surface of the machined substrate 3 is referred to as a bottom portion 58. In this way, the first convex portion 61 and the second convex portion 62 are provided protruding from the bottom portion 58 of the substrate 3. Note that the height here refers to a distance from the bottom portion 58 to a top surface of the convex portions. Further, the height of the convex portion is not limited to approximately 50 μm, and may be set as appropriate in accordance with the design.

In plan view, the sizes of the first convex portion 61 and the second convex portion 62 differ from each other, and the first convex portion 61 is somewhat larger than the second convex portion 62. In other words, in the cross-sectional view, the widths of the first convex portion 61 and the second convex portion 62 differ from each other. Both the first convex portion 61 and the second convex portion 62 have a circular planar shape. Note that the first convex portion 61 is a portion that becomes the protruding portion 71 that is a first protruding portion in the mark 7 illustrated in FIG. 4. Similarly, the second convex portion 62 is a portion that becomes the protruding portion 72 as a second protruding portion.

In the above description, as a laser machining example, the portions corresponding to the protruding portion 71 and the protruding portion 72 of the mark 7 are described as the representative case, but the laser machining is performed on all areas of the dial 11. Specifically, by laser machining the dial 11 illustrated in FIG. 1, the logo 8, the date window 15, the indices 52, an underlying pattern, and the like can be formed in accordance with a design to be adopted. Note that the underlying pattern referred to here is a pattern applied to the bottom portion 58 formed by laser machining the substrate 3.

At step S3, a first plating step is performed on the substrate 3 on which the first convex portion 61 and the second convex portion 62 are formed. Specifically, as illustrated in a step diagram 43 in FIG. 5, a first plating layer 63 is formed over the entire surface of the substrate 3. In this way, the first plating layer 63 is formed over the upper surfaces and the side surfaces of the first convex portion 61 and the second convex portion 62, and the bottom portion 58 of the substrate 3. In a preferred example, the plating is applied by electrolytic plating, and a nickel plating of a predetermined thickness is applied. Further, the plating applied may be a nickel base of gold plating, and is not limited to being the nickel plating. The plating may be chromium, silver, copper, tin plating, or the like. By providing the first plating layer 63, a color tone of the substrate 3 can be concealed. Note that the upper surface referred to here is a surface whose normal line direction is a direction in which the dial 11 is visible, among the surfaces of the first protruding portion 61 and the second protruding portion 62, or the surfaces of the protruding portion 71 and the protruding portion 72.

At step S4, a coating layer 64 is formed over the first plating layer 63. In a preferred example, the coating layer 64 is formed by spraying a dark blue acrylic resin onto the substrate 3. As a result, as illustrated in a step diagram 44 in FIG. 6, the dark blue coating layer 64 is formed over the entire surface of the substrate 3. Note that the color of the coating layer 64 is not limited to this color tone, and, depending on the design, the color tone of the coating layer 64 may be a color or may be clear. Further, a clear coating may be applied to a colored base. Note that the coating layer 64 is not limited to acrylic and it is sufficient that the coating layer 64 be a resin material, and a cellulose resin, a polyurethane resin, an acrylic lacquer resin, or the like may be used, for example. Further, the forming method is not limited to the spraying, and a spin coating method, an inkjet method, a dispenser method, intaglio printing (gravure printing), screen printing, or the like may be used, for example.

At step S5, the coating layer 64 and the first plating layer 63 covering the upper surfaces of the first convex portion 61 and the second convex portion 62 are removed by a polishing step, and the upper surfaces of the first convex portion 61 and the second convex portion 62 are exposed from the coating layer 64. In a preferable example, after primary polishing using a lapping machine, secondary polishing is performed using a polishing machine, to cause the upper surfaces of the first convex portion 61 and the second convex portion 62 to become mirror surfaces. By adopting such a mode, it is possible to express a design making use of a contrast between a color shade and texture of the substrate 3 and a color shade and texture of the coating layer 64. Note that, in the preferred example, as illustrated in a step diagram 45 in FIG. 6, the coating layer 64 and down to the first plating layer 63 are polished to expose the upper surfaces of the first convex portion 61 and the second convex portion 62, but the first plating layer 63 on the upper surfaces of the first convex portion 61 and the second convex portion 62 may partially remain. In other words, it is sufficient that at least a portion of the upper surface be exposed from the coating layer 64. By adopting such a mode, it is possible to make a richer expression of the design making use of the substrate 3, the coating layer 64, and the first plating layer 63.

At step S6, a second plating step is performed on the upper surfaces of the first convex portion 61 and the second convex portion 62 exposed from the coating layer 64. More specifically, as illustrated in a step diagram 46 in FIG. 6, a second plating layer 65 is formed on the upper surfaces of the first convex portion 61 and the second convex portion 62. In a preferred example, the plating is applied by electrolytic plating, and a gold plating of a predetermined thickness is applied. Note that the plating applied is not limited to the gold plating, and it is sufficient that the playing be a metal, but a precious metal such as silver, platinum, and rhodium is particularly suitable. In this way, the protruding portion 71 and the protruding portion 72 including the second plating layer 65 on top portions thereof are formed. As illustrated in the step diagram 46, the coating layer 64 that is an underlying layer is formed around the protruding portion 71 and the protruding portion 72. In other words, a state is obtained in which the protruding portion 71 and the protruding portion 72 protruding from the coating layer 64, which is the underlying layer, rise up in a three-dimensional manner.

The description will return to FIG. 1.

In a similar manner to the protruding portion 71 and the protruding portion 72, similar processing is also performed on the other protruding portions of the mark 7, and on the logo 8, the date window 15, and the indices 52. After that, the circular dial 11 is cut out from the substrate 3, resulting in the dial 11 illustrated in FIG. 1.

As described above, the dark blue coating layer 64 that expresses an image of the night sky is formed as the base of the dial 11. Here, the dial 11 is complete that symbolizes a starry sky in which the gold-colored mark 7 that depicts the constellation of Orion is disposed so as to rise up.

The description will return to FIG. 4.

When a protruding portion 75 is a third protruding portion in the mark 7, in plan view, the size of the protruding portion 75 is different from that of the protruding portion 71 and the protruding portion 72. Specifically, the size becomes larger in order of the protruding portion 75, the protruding portion 72, and the protruding portion 71. Note that the height of the protruding portion 75 is the same as that of the protruding portion 71 and the protruding portion 72. Further, a distance between the protruding portion 71 and the protruding portion 72 is different from a distance between the protruding portion 72 and the protruding portion 75. Specifically, the distance between the protruding portion 72 and the protruding portion 75 is shorter than the distance between the protruding portion 71 and the protruding portion 72. In this way, by intentionally creating an irregular pattern, the design having contrast and accents can be expressed.

On the other hand, all three of a protruding portion 73, a protruding portion 74, and the protruding portion 75 are substantially the same size, and are disposed at substantially equal intervals. In this way, by using a regular pattern, a consistent pattern can be created. Thus, according to the processing steps of the embodiment, since a regular pattern and an irregular pattern can be intentionally formed, the intended design can be formed.

Example of Actual Protruding Portion

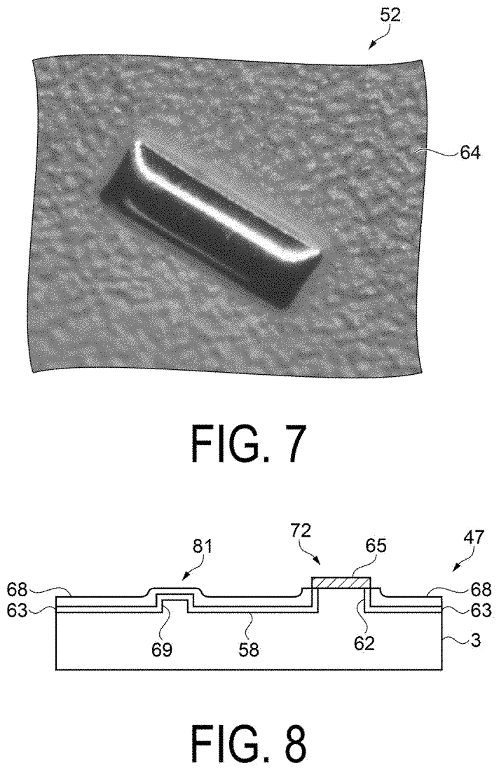

FIG. 7 is an enlarged photograph of the index.

FIG. 7 is an enlarged photograph of the index 52 formed by the above-described manufacturing method of the present application. The index 52 is an index located in a 4 o'clock direction on the dial 11 illustrated in FIG. 1.

As illustrated in FIG. 7, the index 52 according to the manufacturing method of the present application is understood to have a high three-dimensional effect and metallic feel with metallic luster. This is because, as described above, the second plating layer 65 is formed on the top portion of the index 52 that rises up from the underlying coating layer 64.

On the other hand, in related art, printing or attached symbols are known as forming methods of the indices and the logo. For example, when the indices are formed by tampo printing (pad printing), it is difficult to produce the three-dimensional effect and the metallic feel as with the index 52 illustrated in FIG. 7. Further, when the index is formed using a rod-like symbol as a separate component, the texture can be made equivalent to the index 52 illustrated in FIG. 7, but in addition to the fact that a number of components increases, man-hours to attach the index are also necessary. Furthermore, there is room for improvement in yield and quality, such as oozing of adhesive during attachment. Further, when the symbol is fixed using the foot thereof, the thickness of the symbol is limited by the thickness of the foot, and it is difficult to form a long thin symbol.

As described above, according to the embodiment, the following advantages can be obtained.

The watch dial 11 manufactured by the manufacturing method described above includes the substrate 3, and, on the substrate 3, the protruding portion 71 formed by the laser machining and the coating layer 64 provided around the protruding portion 71. At least a portion of the upper surface of the protruding portion 71 is exposed from the coating layer 64.

According to this configuration, it is possible to quantitatively control the position, number, size, shape, and height of the protruding portion by the laser machining. As a result, the intended textured pattern can be created. Furthermore, it is possible to express the intended design by making use of differences in the material, hue, saturation, and brightness between the coating layer 64 and the protruding portions.

Thus, it is possible to provide the watch dial 11 having the high decorative and design properties.

Note that, in general, while embossing, etching, and cutting are known as methods for forming the textured pattern, such as the protruding portions, on the substrate 3, when manufacturing the dial 11, laser machining is superior to any of these methods. In particular, in the case of embossing, since a die corresponding to the design is necessary, changes to design are not easy, and there are restrictions on the depth of the recesses and protrusions. In the case of etching, since there is a need for masking processing corresponding to the design, dedicated equipment including a plurality of corrosion solutions and the like, is necessary, many man-hours are required, and there are also restrictions on the depth of the recesses and protrusions. Further, in the case of cutting, a machining time is long, and there is a problem in that variations occur in a finish when a tool becomes worn.

In contrast, in the laser machining, by adjusting the laser irradiation intensity and time, using a program control corresponding to the design, it is possible to form the textured pattern of a desired depth. Further, design changes can be easily made by simply changing the program. Furthermore, the main necessary equipment is only the laser irradiation device, and there is also a merit in that the machining time is shorter compared to cutting. Further, since the indices, logo, symbols, and the like can be formed together with the dial, the number of components can be reduced and productivity can be improved. Furthermore, since the recesses and protrusions on the substrate are formed by the laser machining, a pattern can be formed with dimensions equal to or greater than the resolution of the laser beam, and detailed expression that is difficult to achieve with known symbols or the like can be obtained.

Further, the protruding portion 71 protrudes from the bottom portion 58 of the substrate 3, and the first plating layer 63 is provided on the bottom portion 58.

According to this, the color tone of the substrate 3 can be concealed by the first plating layer 63, and thus the brightness and saturation of the dial 11 can be adjusted by the coating layer 64 that is the upper layer. Further, by the first plating layer 63 being interposed between the substrate 3 and the coating layer 64, adhesion between the three members can be improved. Furthermore, as the adhesion is improved, resistance to the environment, such as moisture resistance, heat resistance, and light resistance, is improved.

Further, the second plating layer 65, which is different from the first plating layer 63, is provided on the upper surface of the protruding portion 71. According to this configuration, the hue of the protruding portion 71 can be adjusted using the second plating layer 65, thus improving the design properties.

Further, the second plating layer 65 protrudes from the coating layer 64.

According to this configuration, since the second plating layer 65 can be three-dimensionally highlighted, visual accents and contrasts can be expressed, and the design properties are improved.

Further, the configuration includes the protruding portion 71 that is the first protruding portion and the protruding portion 72 that is the second protruding portion different from the protruding portion 71, and the heights of the protruding portion 71 and the protruding portion 72 are the same.

According to this configuration, a consistent pattern can be created using the plurality of protruding portions having the aligned heights. For example, the indices, marks, and the like having a sense of cohesiveness can be formed.

Further, in plan view, the protruding portion 73, the protruding portion 74, and the protruding portion 75 are disposed at the substantially equal intervals, and the three protruding portions are of substantially the same size.

According to this configuration, a regular pattern can be created using the plurality of protruding portions having the same size. For example, the indices having a sense of cohesiveness, marks, and the like can be formed.

Further, in plan view, the sizes of the protruding portion 71 and of the protruding portion 72 are different.

According to this configuration, a varied pattern can be created using the plurality of protruding portions having different sizes. In other words, accents and contrasts can be added to the design expression.

Further, the configuration includes the protruding portion 75 as the third protruding portion, and the size of the protruding portion 75 is different from that of the protruding portion 71 and the protruding portion 72. According to this configuration, the irregular pattern can be intentionally created.

Further, the distance between the protruding portion 71 and the protruding portion 72 is different from the distance between the protruding portion 72 and the protruding portion 75. According to this configuration, by intentionally creating the irregular pattern, the design having accents and contrasts can be expressed.

Then, the watch 10 of the embodiment is provided with the dial 11 described above.

Thus, the watch 10 provided with the dial 11 having the high decorative and design properties can be provided.

Second Embodiment

Different Mode of Protruding Portions—1

FIG. 8 is a cross-sectional view of a different mode of the protruding portions according to the embodiment, and corresponds to the step diagram 46 illustrated in FIG. 6. In the embodiment described above, the heights of the protruding portions are described as being the same, but the heights of the protruding portions may be different from each other.

FIG. 8 is a cross-sectional view taken along a cross-section A-C illustrated in FIG. 4, and is a cross-sectional view of the protruding portion 72 and a line segment 81. Line segments 81 to 86 are auxiliary lines connecting the protruding portions.

Here, a coating layer 68 in a step diagram 47 illustrated in FIG. 8 uses a transmissive material. A base of the line segment 81, which is the second protruding portion, is a convex portion 69 having a height lower than the second convex portion 62 that is the base of the protruding portion 72. In other words, during the laser machining at step S2, the convex portion 69 is formed to be lower than the second convex portion 62. Specifically, the height of the convex portion 69 is approximately half the height of the second convex portion 62. At steps S3 and S4, the first plating layer 63 and the coating layer 68 are formed over the convex portion 69. In the polishing step at step S5, since the height of the convex portion 69 is low, a state is obtained in which the first plating layer 63 and the coating layer 68 remain without being polished. In other words, the line segment 81 is covered by the coating layer 68. Note that this also applies to the other line segments 82 to 86 illustrated in FIG. 4. Other than these points, the configuration is the same as that in the step diagram 46. Note that transmissive refers to a state in which the bottom portion 58 of the substrate 3, which is beneath the coating layer, the second convex portion 62 that is embedded in the coating layer, or the protruding portion 72 are visible.

In this way, the line segment 81 is observed via the transmissive coating layer 68. Specifically, the three-dimensional line segment 81 having the silver-colored metallic feel due to the first plating layer 63 is observed in the transmissive coating layer 68. Further, since the protruding portion 72 has the same configuration as in the step diagram 46, a contrast between the gold color of the surface of the protruding portion 72 and the silver color of the line segment 81 and the height difference therebetween increases the three-dimensional effect, and thus, a more varied expression can be realized.

Note that, when it is wished to make use of the color tone of the substrate 3, the first plating layer 63 need not necessarily be formed. In this case, after forming the protruding portion 69 and the second convex portion 62 by the laser machining at step S2, the processing may advance to the coating step at step S4 to form the coating layer 68.

Further, in the above description, the case is described in which the heights of the two protruding portions are different, but the heights of three or more of the protruding portions may be different. For example, in FIG. 8, on the bottom portion 58 of the substrate 3, an underlying pattern may be formed using a protruding portion, as the third protruding portion, having a height lower than that of the line segment 81. According to this configuration, the more varied expression is realized.

Further, the configuration is not limited to the line segment 81, and the heights of the protruding portions, the logo 8, the date window 15, and the indices 52 may also be changed in accordance with the design. Further, the underlying pattern described above is not limited to the protruding portions, and the base portion 58 of the substrate 3 may be engraved to form grooves. When the grooves are used, a difference in height with the protruding portions is increased, and thus a varied pattern having a greater three-dimensional effect can be formed.

As described above, according to the embodiment, in addition to the advantages described above, the following advantages can be obtained.

The coating layer 68 is transmissive. According to this configuration, it is possible to express the design while taking into account the color tone of the substrate 3 that is the base, or of the first plating layer 63.

Further, the heights of the protruding portion 72 that is the first protruding portion and of the line segment 81 that is the second protruding portion are different from each other. According to this configuration, a varied pattern can be created using the plurality of protruding portions having the different heights.

Further, the height of the line segment 81 is lower than that of the protruding portion 72, and the line segment 81 is covered by the transmissive coating layer 68. According to this configuration, in addition to the difference in height, the reflection of light in the line segment 81 covered by the coating layer 68 is reduced, and the more varied pattern can be created.

Further, the height of the underlying pattern of the convex portion that is the third protruding portion is different from that of the protruding portion 72 and the line segment 81. According to this configuration, the more varied pattern can be created.

Third Embodiment

Different Mode of Protruding Portions—2

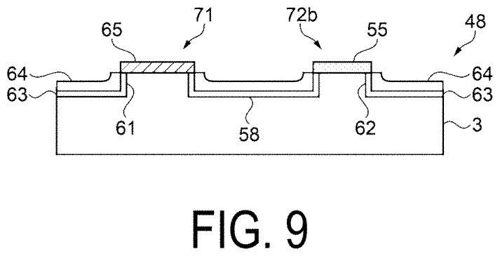

FIG. 9 is a cross-sectional view of a different mode of the protruding portions according to a third embodiment, and corresponds to the step diagram 46 illustrated in FIG. 6. In the embodiments described above, the description is made in which the second plating layer 65 is provided on the top portions of both the protruding portion 71 and the protruding portion 72. However, different plating layers may be provided.

In a step diagram 48 illustrated in FIG. 9, a third plating layer 55, which is different from the second plating layer 65, is formed on the upper surface of a protruding portion 72b. In a preferred example, the third plating layer 55 is chrome plating. Apart from this point, the configuration is the same as that of the step diagram 46 illustrated in FIG. 6.

The third plating layer 55 is formed by performing the second plating step at step S6 twice. Specifically, first, gold plating is applied to form the protruding portion 71 while selectively masking the second convex portion 62. Next, the masking of the second convex portion 62 is removed, and chrome plating is applied to form the protruding portion 72b while selectively masking the protruding portion 71. Alternatively, after gold plating is applied to both the protruding portion 71 and the protruding portion 72b, the gold plating of the protruding portion 72b may be removed by laser machining, and the chrome plating may be applied to form the protruding portion 72b while selectively masking the protruding portion 71.

As described above, according to the embodiment, in addition to the advantages described above, the following advantages can be obtained.

The third plating layer 55 that is different from the first plating layer 63 and the second plating layer 65, is provided on the upper surface of the protruding portion 72b that is the second protruding portion.

According to this configuration, the protruding portion 71 and the protruding portion 72b can have different hues, and thus, the design properties can be further enhanced.

Further, in the embodiments described above, the dial 11 is circular, but the dial 11 is not limited thereto. A contour of the dial 11 may be oval, rectangular, barrel-shaped, or alternatively, may be a closed shape that is not similar to these shapes. Note that the closed shape refers to a shape in which the contour is closed.

In the embodiments described above, the convex portions and the protruding portions are circular, but the shape thereof is not limited thereto. Contours of the convex portions and the protruding portions in plan view may be oval, rectangular, barrel-shaped, or alternatively, may be a closed shape that is not similar to these shapes. Further, the line segments 81 to 86 in the second embodiment can be considered to be an elongated rectangle, and may have a shape that is not only a solid line, but also a curved line, a dotted line, or a dashed line.

In the embodiments described above, the steps and the structure for forming the mark 7 by the laser machining are described as representative examples using the step diagram 42 in FIG. 5, but, for example, when the logo 8, the date window 15, the indices 52 and the like are formed by the laser machining along with the mark 7, these members are preferably formed together in the laser machining step at step S2 illustrated in FIG. 2.

What is claimed is:

1. A watch dial comprising:
a substrate;
a protruding portion formed at the substrate by laser machining; and
a coating layer provided around the protruding portion, wherein
at least a portion of an upper surface of the protruding portion is exposed from the coating layer.

2. The watch dial according to claim 1, wherein
the protruding portion protrudes from a bottom portion of the substrate, and
a first plating layer is provided at the bottom portion.

3. The watch dial according to claim 2, wherein
a second plating layer different from the first plating layer is provided at the upper surface of the protruding portion.

4. The watch dial according to claim 3, wherein
the second plating layer protrudes further than the coating layer.

5. The watch dial according to claim 1, wherein
the coating layer is transmissive.

6. The watch dial according to claim 1, wherein
when the protruding portion is a first protruding portion, the watch dial includes a second protruding portion different from the first protruding portion, and
heights of the first protruding portion and the second protruding portion are the same.

7. The watch dial according to claim 1, wherein
when the protruding portion is a first protruding portion, the watch dial includes a second protruding portion different from the first protruding portion, and
heights of the first protruding portion and the second protruding portion are different from each other.

8. The watch dial according to claim 7, wherein
the height of the second protruding portion is lower than the height of the first protruding portion, and the second protruding portion is covered by the coating layer.

9. The watch dial according to claim 6, wherein
a third plating layer different from the first plating layer and the second plating layer is provided at an upper surface of the second protruding portion.

10. The watch dial according to claim 6, wherein
in plan view, sizes of the first protruding portion and the second protruding portion are the same.

11. The watch dial according to claim 6, wherein
in plan view, sizes of the first protruding portion and the second protruding portion are different from each other.

12. The watch dial according to claim 11, further comprising:
a third protruding portion, wherein
a size of the third protruding portion is different from that of the first protruding portion and the second protruding portion.

13. The watch dial according to claim 12, wherein
a distance between the first protruding portion and the second protruding portion is different from a distance between the second protruding portion and the third protruding portion.

14. The watch dial according to claim 12, wherein
a height of the third protruding portion is different from that of the first protruding portion and the second protruding portion.

15. A watch comprising:
the watch dial according to claim 1.
